(19) United States
(12) Patent Application Publication
(10) Pub. No.: US 2017/0217797 A1
(43) Pub. Date: Aug. 3, 2017

(54) AUTOMATIC BRINE RETROFIT FOR A WATER SOFTENER SYSTEM

(71) Applicant: BENJAMIN W. COPE, YORK, PA (US)

(72) Inventor: BENJAMIN W. COPE, YORK, PA (US)

(21) Appl. No.: 15/485,642

(22) Filed: Apr. 12, 2017

Related U.S. Application Data
(63) Continuation-in-part of application No. 14/548,351, filed on Nov. 20, 2014.

(51) Int. Cl. C02F 1/42; C02F 1/00

(52) U.S. Cl. CPC C02F 1/42; C02F 1/008; C02F 2001/422; C02F 2101/10

(57) ABSTRACT

A method for converting a salt-based ion exchange water softener into a brine-based system. The system includes a resin tank containing an ion exchange media, a batch tank containing crystalline salt, a master valve for directing water flow through selected portions of the softener system, a brine conduit connecting the batch tank to the master valve, and a controller for managing the master valve position to define at least operating, brine fill, and brine draw cycles. A control valve is installed in the brine conduit to prevent fresh water flow from the master valve to the batch tank and the crystalline salt in the batch tank replaced with a quantity of liquid brine. It is preferable to adjust the duration of the brine draw cycle to limit the brine draw cycle to the minimum time necessary to provide sufficient brine to the resin tank to recharge the ion exchange media.

### CROSS REFERENCE TO RELATED APPLICATIONS

This application is a continuation in part of U.S. application Ser. No. 14/548,351, filed Nov. 20, 2014.

### BACKGROUND OF THE INVENTION

The present invention relates generally to ion-exchange water softening devices and, more particularly, to a system for retrofitting a crystalline salt-based water softener for use with a brine supply system.

Many conventional water softening systems, particularly those used in residential and commercial application, include a brine generation tank into which owners must periodically dump crystalline salt. The softening system supplies a pre-determined volume of fresh water to the brine generation tank at specific times during the regeneration process to create a desired volume of brine for later use in the regeneration process. The conventional approach typically requires the owner to carry bags of salt, each typically weighing 40 to 50 pounds, to the brine generation tank to replenish the salt supply for brine-making. This method of is labor intensive and subjects the owner to muscle strain and injury climbing steps, carrying bags, and dumping salt from the opened bags. Furthermore, if proper attention was not paid to the level of salt in the water conditioning unit, the water conditioning unit could run out of salt, resulting in the water conditioning unit malfunctioning.

Industrial-scale water softening systems may employ large brine-making tanks located remote from the water softening equipment that provide a brine to the softening systems using a metering system. Salt is supplied to these remote brine-making tanks by truck or other large material handling machinery, eliminating the labor intensity of the process. Still other large industrial water softening systems employ large brine tanks which are replenished by brine produced elsewhere. This approach also reduces the physical labor demands as liquid brine is typically delivered by tanker. The brine metering systems necessary to efficiently regenerate the softener media add complexity that has not heretofore been cost effective for the much smaller residential and commercial systems.

It would be advantageous to provide a brine system for a water softener that would allow the use of a bulk brine storage tank that could be retrofit with existing brine generation softener systems to eliminate the need for the owner to carry bags of salt to the brine tank. A brine replenishment service, similar to that used for home heating oil, would allow the owner to enjoy the benefits of softened water without the hassle of handling the salt. Delivery of liquid brine instead of crystalline salt is more efficient for the brine supplier and eliminates the need for the service person to carry crystalline salt or access the residence to gain direct access to the softener system.

### SUMMARY OF THE INVENTION

Accordingly, the present invention, in any of the embodiments described herein, may provide one or more of the following advantages:

According to one embodiment of the present invention, a retrofit system for supplying liquid brine into the regeneration cycle of a ion-exchange water softener is provided that requires minimal alteration to the existing system yet converts the softener to a metered brine regeneration system. The retrofit system replaces the brine batch tank with a brine tank sized to contain sufficient volume to permit regeneration of the softener system for as much as a year, removes the conventional air check valve normally disposed at the end of the brine line in the brine batch tank, and installs a check valve in the brine line to prevent the softener master valve from directing fresh water into the brine tank during the brine refill cycle of operation. The control for the master valve is altered to align in the brine draw cycle for only a time sufficient to supply the minimum quantity of brine necessary to regenerate the ion exchange media in the softener. The brine batch tank is emptied of crystalline salt and is either used as a brine storage tank or replaced with a larger tank.

In another embodiment, the regeneration control for the softener system is modified to draw a volume of brine from the brine tank that is minimally sufficient to regenerate the ion exchange media. This embodiment reduces water waste by minimizing the volume of brine flushed through the ion exchange media. Additional water savings are realized by similarly modifying the softener control to minimize the post-regeneration rinse cycle.

In yet another embodiment, the retrofit system includes a brine storage tank, a check valve, a float switch, and a control valve in a fill line for supplying brine from the storage tank to a brine batch tank of a conventional softener system. The softener batch tank is emptied of crystalline salt. The float switch is installed in the batch tank and serves allow a predetermined volume of brine to fill the batch tank from the storage tank by controlling the position of the control valve, the predetermined volume being approximately equal to the volume necessary for a regeneration cycle of the softener system. The controller for the softener system master valve is left unaltered. The check valve is added to the brine supply line from the batch tank to the softener unit to prevent fresh water from the brine fill cycle of operation from entering the batch tank. The predetermined volume of brine in the batch tank is drawn into the softener system during the softener regeneration as normal. Once the volume is depleted, the softener system typically continues in the alignment with a slow rinse cycle.

It is a still further object of the present invention to provide a retrofit system for converting a crystalline salt based ion exchange water softener into a liquid brine based softener system that is durable in construction, inexpensive of manufacture, carefree of maintenance, easily assembled, and simple and effective to use.

These and other objects are achieved in accordance with the present invention by an apparatus and method for converting a conventional crystalline salt based ion exchange water softener system into a liquid brine-based softener system. The conventional softener system includes a resin tank containing an ion exchange media, a batch tank containing a quantity of crystalline salt, a master valve for directing a flow of water through selected portions of the softener system, a brine conduit connecting the batch tank to the master valve, and a controller for managing the master valve to define at least an operating cycle, a brine fill cycle, and a brine draw cycle. The method includes installing a flow control valve, such as a check valve, in the brine conduit to prevent fresh water flow from the master valve to the batch tank and replacing the crystalline salt in the batch tank with a quantity of liquid brine. It is preferable to adjust the duration of the brine draw cycle to limit the brine draw cycle to the minimum time necessary to provide sufficient brine to the resin tank to recharge the ion exchange media.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a schematic diagram of a conventional water softener system of the type typically used in residential applications;

FIG. 2 is a schematic diagram of the water softener system of FIG. 1 incorporating a first embodiment of the present invention;

FIG. 3 is a schematic diagram of the water softener system of FIG. 1 incorporating a second embodiment of the present invention;

FIG. 4 is a schematic diagram of the water softener system of FIG. 1 incorporating a third embodiment of the present invention; and

FIG. 5 is a schematic diagram of the conventional water softener system of FIG. 1 incorporating a fourth embodiment of the present invention.

### DESCRIPTION OF THE PREFERRED EMBODIMENT(S)

Many of the fastening, connection, processes and other means and components utilized in this invention are widely known and used in the field of the invention described, and their exact nature or type is not necessary for an understanding and use of the invention by a person skilled in the art, and they will not therefore be discussed in significant detail. Furthermore, the various components shown or described herein for any specific application of this invention can be varied or altered as anticipated by this invention and the practice of a specific application of any element may already be widely known or used in the art by persons skilled in the art and each will likewise not therefore be discussed in significant detail. When referring to the figures, like parts are numbered the same in all of the figures.

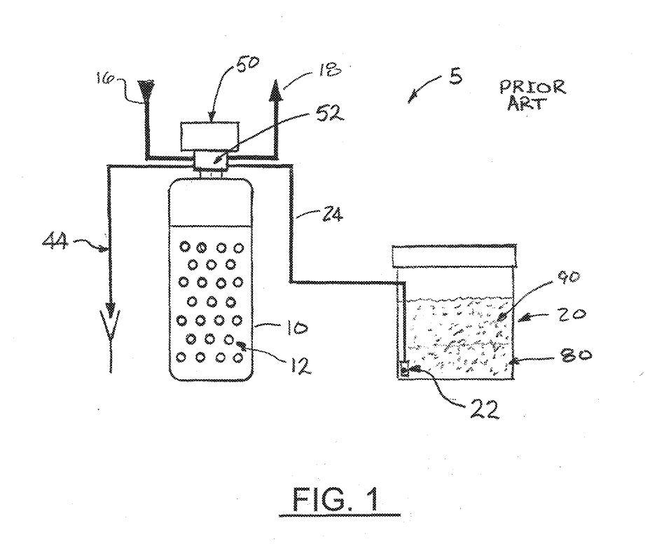

FIG. 1 provides a diagram of a conventional salt-based ion exchange water softening system 5 finding application in residential and low demand commercial environments. The water softening system 5 includes a resin tank 10 containing an ion exchange media 12, typically resin or polymer beads, a control module 50 operably manipulating a master valve (or valves) 52 to direct an incoming flow 7 of unsoftened water through selected portions of the softener system 5 to produce an outgoing flow of softened water. Such water softening systems operate by replacing hardness ions such as calcium (Ca²+) and magnesium (Mg²+) with sodium (Na+) or potassium (K+) ions. In the ion exchange process, the ion exchange media 12 is coated with sodium or potassium ions. What water containing calcium and magnesium ions comes into contact with the ion exchange media, two positively charged sodium or potassium ions are exchanged (released into the water) for every calcium or magnesium ion that is held by the resin thus reducing the number of hardness ions from the water flow. Eventually a point in the process is reached when very few sodium or potassium ions remain on the ion exchange media, thus calcium or magnesium ions will no longer be removed from the water. In order to continue hardness ion removal, the ion exchange media must be periodically “regenerated” to flush out the calcium and magnesium hardness ions and replace them with sodium or potassium ions.

U.S. Pat. No. 4,298,025 to Prior et al. and U.S. Pat. No. 6,402,944 to Vaughan each disclose exemplar control modules and master control valves of the type commonly employed on salt-based ion exchange water softening systems. The descriptive portions thereof relating to the operation of control modules and master control valves is incorporated herein by reference.

The ion exchange media regeneration process is accomplished by the control module 50 realigning the master valve 52 to direct a flow of brine having a high concentration of sodium and/or potassium through the media 12. This is commonly referred to as the brine draw cycle. A bypass flow path is also established by the master valve 52 so that unsoftened water can be supplied to downstream components during the regeneration process. The brine flow is discharged to a waste drain 44 after passing though the ion exchange media as the discharge flow contains the undesirable hardness ions. The brine required to regenerate the ion exchange media varies depending on the quantity of media 12 contained in the resin tank 10, typically expressed as a measure of softening capacity in grains of hardness. In typical systems, each pound of salt in the brine will remove 3,000 to 5,000 grains of hardness. The typical method for the brine draw cycle is to align the master valve 52 to draw the brine flow into the tank 10 by directing a flow of fresh water from the inlet 16 through a venturi in the master valve 52 which is connected to a brine conduit 24 allowing brine to be drawn from the brine batch tank 20 and directed along the fresh water flow to the resin tank 10. Brine 80 is produced in the brine batch tank 20 at an earlier stage in the operating cycle in which the control module 50 align the master valve 52 to direct a pre-determined batch volume of fresh water to the batch tank 20 via brine line 24. This is typically referred to as the brine fill cycle. The water supplied to the batch tank 20 dissolves crystalline salt 90 held therein to create the brine. Once the pre-made batch volume of brine is drawn into the system during the brine draw cycle, an air check valve 22 closes to isolate the brine conduit from the venture in the master valve 52. The master valve 52 alignment typically remains unchanged for a period of time so that the water flow passing through the venturi, which no longer includes brine, can be passed through the ion exchange media to flush out excess salt and discharge through the waste drain 44. A higher volume rinse may also be used by realigning the master valve 52 to provide rinse flow at a greater rate than is used during the brine draw cycle. Once the ion exchange media is rinsed, the system 5 is returned to normal operation cycle by realigning the master valve 52 to direct water from the inlet 16, through the resin tank 10, and to an outlet 18 for use.

Producing brine in the brine batch tank requires an inventory of crystalline salt be maintained therein. For the average homeowner, replenishing the salt supply is a laborious task that is often forgotten. When the salt supply is exhausted, water softening capability is diminished. Services to periodically replenish salt inventory are difficult as direct access to the softener system by the service technician is usually necessary and the technician is require to carry heavy bags (typically 40-50 pounds) of salt to the location.

The present invention modifies a conventional salt-based residential water softening system to use liquid brine supply instead, eliminating the need to periodically supply crystalline salt for operation. The method of conversion is minimally invasive to the original softening system and provides the softener system user with the option to have liquid brine conveniently supplied by a commercial supplier. Additionally, altering the controls to minimize the volume of brine used during ion exchange media regeneration and supply the minimum volume necessary, allows water consumption to be dramatically reduced. The volume of brine is minimized, but also the volume of water necessary to rinse the ion exchange media following the brine draw cycle of regeneration is also reduced. Further environmental benefits are realized by reducing the volume of brine discharged into public waste systems.

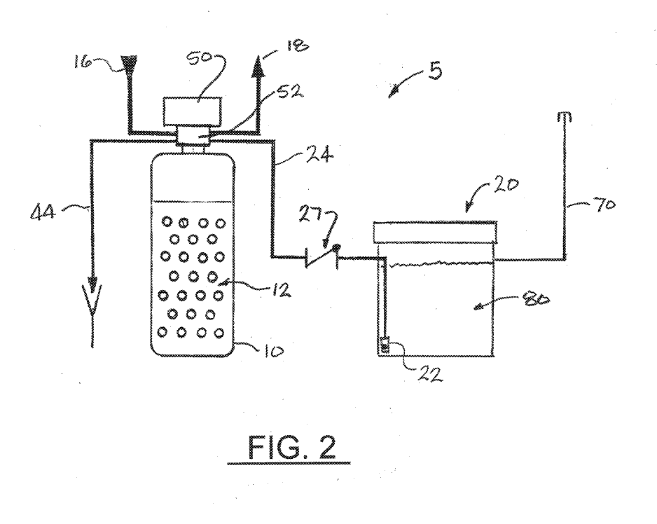

Referring to FIG. 2, a first method involves the addition of a flow control valve 27 in the brine conduit 24 to prevent the master valve 52 from directing fresh water to the batch tank 20 during the brine fill cycle. Flow control valve 27 is illustrated as a check valve in FIG. 2 but may also other valve types capable of preventing reverse fluid flow. Crystalline salt 90 is removed from the tank and replaced with liquid brine 80. The control module 50 may be modified to reduce the duration of the brine draw cycle to approximately the time necessary to draw in the minimum brine volume required to regenerate the ion exchange media. Mechanical control modules typically manipulate the master valve 52 through one or more cams acting on the master valve (or valves). Modification in mechanical control modules involves altering the cam profile that controls the flow of water through the venturi. Electronic control modules typically allow timing parameters to be reprogrammed to desired values. A flow control valve 27 is installed in the brine conduit 24 between the master valve 52 and the batch tank 20. The flow control valve 27 is configured to permit flow from the batch tank 20 to the master valve 52, such as during the brine draw cycle, but prevent reverse flow from the master valve 52 to the batch tank 20, such as during the brine fill cycle. In this manner, the sequence of cycles, including the brine fill cycle, can be left untouched in the control module. Alteration of the cycle sequences, especially in mechanical control modules, requires more significant and invasive modification of the module. Because of the invasive nature of the module modifications, this approach is not preferred as it raises concerns with softener system warranties. The module will attempt a brine fill cycle, but the flow control valve 27 prevents flow to the batch tank 20 that would dilute the brine stored therein. A simple check valve is preferred, though the same function may be accomplished using actively operated valves and sensors. The air check valve 22 is preferably removed to reduce restriction in the brine conduit and the chance of failure, but may also be left in place.

In order to permit replenishment of the brine batch tank without the need to directly access the softener system (e.g., one located inside of a home), remote fill capabilities may be provided. A remote fill line 70 directed from the batch tank 20 to an accessible location on the home exterior allows a brine refill service to refill the brine batch tank 20 without disrupting the homeowner, as is commonly used for delivery of home heating oil or propane gas. Experience has shown that delivery and remote fill of crystalline salt can be difficult, if not commercially impractical to execute, commercial delivery of liquids to homeowners is quite feasible, both practically and economically. The remote fill line may be further enhanced with protective and/or metering features to prevent overfilling and overflow of the brine tank.

Water hardness and softener capacity dictate the required brine volume for regeneration the ion exchange media and the frequency of regeneration. Using these inputs, the softener operation duration capable of being supported by the volume of brine in the batch tank may be determined. It may be desirable to increase the capacity of the batch tank 20 in order to lengthen the time between batch tank refills. Batch tank capacity increases are primarily limited by available space in proximity to the softener system. Experience has shown that batch tank capacities supporting softener operation for periods of 6 to 12 months between brine refills are easily achievable in most softener system installations, most with only a 3 to 5-fold increase in tank capacity.

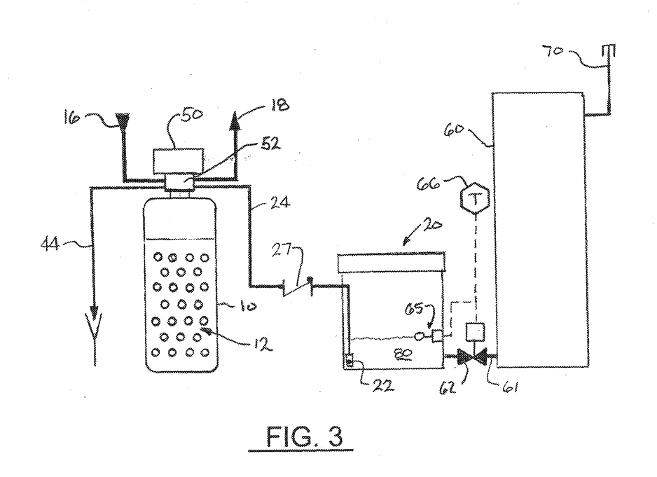

Referring to FIG. 3, a second and preferred retrofit method is presented. As discussed above, a flow control valve 27 is installed in the brine conduit 24 and configured to permit flow from the batch tank 20 to the master valve 52, such as during the brine draw cycle, but prevent reverse flow from the master valve 52 to the batch tank 20, such as during the brine fill cycle. However, the brine batch tank 20 continues to be used as a vessel to contain the predetermined brine volume necessary for regeneration of the ion exchange media. The air check valve 22 remains in place and the control module may or may not be modified to adjust the brine draw cycle duration. As contrasted with the earlier described approach, this approach allows the brine regeneration volume to be optimized without the need to alter the control module 50. A larger brine storage tank 60 is provided and may be located in available space, either proximate to the softener system 5 or in a remote location. The storage tank 60 is connected to the batch tank 20 by a brine transfer conduit 61 having a fill valve 62 disposed therein. A float switch 65 may be installed in the batch tank to generate a signal indicating that the volume in the batch tank has been used for regeneration and must be replenished. The float switch 65 triggers a delay timer 66 which delays opening of the fill valve 62 for a period of time necessary for the control module 50 to complete the brine draw cycle and isolate the venturi, otherwise the brine delivered to the batch tank 20 from the storage tank 60 will be drawn into the softener system for regeneration, dramatically increasing brine consumption.

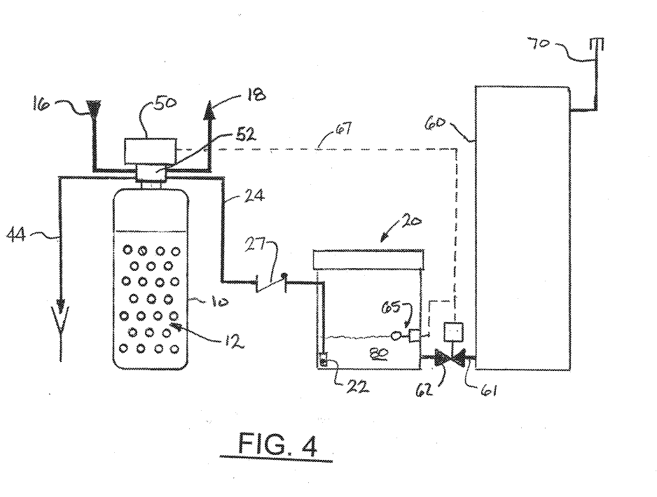

An optional alternative, illustrated in FIG. 4, incorporates a signal 67 from the control module to the stop valve 62 that prevents opening of the stop valve while the system is in the brine draw cycle. Other control methods for opening the stop valve 62 to replenish a predetermined batch volume of brine in the batch tank 20 are contemplated, provided the stop valve remains closed during the brine draw cycle and is opened only sufficient to permit the predetermined regeneration brine volume to transfer from the storage tank 60 to the batch tank 20. Other alternatives include high and low contacts in the float switch 65, again with a suitable time delay to avoid refilling during the brine draw cycle, or the inclusion of additional switches in the brine conduit 24 or control module 50 to trigger the stop valve 62 to open for refill when the system enters the brine fill cycle.

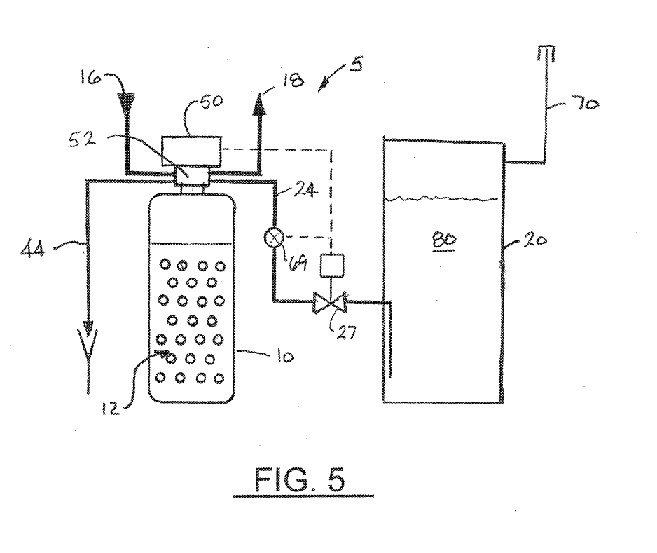

Water softening systems in which the logic within the control module 50 is easily accessed and modified (e.g., electronic controls) may also be modified to eliminate the brine making step altogether and change the sequence to draw a pre-determined volume of brine from a bulk storage tank. FIG. 5 illustrates one such embodiment wherein the position of the flow control valve 27 is controlled directly by the control module 50 to admit the predetermined volume of brine required for ion exchange media regeneration during the regeneration process. The volume may be determined by a timer which maintains the control valve 62 open a sufficient time to allow the volume to pass or more accurately using feedback from a flow meter 69 incorporated in the brine conduit 24. While system simplicity is increased with this approach, the modifications necessary to the existing water softening system are greater and may not be acceptable in every circumstance.

Naturally, the invention is not limited to the foregoing embodiments, but it can also be modified in many ways without departing from the basic concepts. It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

Having thus described the invention, what is claimed is:

1. In a residential use, ion exchange water softener having an ion exchange tank containing an ion exchange media, a raw water inlet conduit, a softened water discharge conduit, a waste water conduit, a brine batch tank having a brine conduit operably connected thereto, and a master control valve connected to the ion exchange tank, the master control valve having a controller configured to manage alignment of the master control valve to selectively direct the flow of water from the raw water inlet conduit to the ion exchange tank, the waste water conduit, the brine conduit, the softened water discharge conduit, or combinations thereof, thereby defining a plurality of operating modes including at least a soften mode wherein the master control valve is aligned to direct water from the raw water inlet conduit through the ion exchange tank and to the water discharge conduit, a brine generation mode wherein the master control valve is aligned to direct a pre-determined volume of water from the raw water inlet conduit to the brine batch tank via the brine conduit whereupon crystalline salt contained in the brine batch tank interacts with the raw water to create a regeneration batch volume of brine solution, a regeneration mode wherein the master control valve is aligned to withdraw the regeneration batch volume of brine solution from the brine batch tank via the brine conduit, direct the brine solution through the ion exchange tank, and to discharge the brine solution to the waste discharge conduit, the improvement in the water softening system comprising:
a brine supply apparatus operably connected to the brine batch tank, the brine supply apparatus configured to permit liquid brine to be supplied to the batch tank for regeneration of the softener system and enable crystalline salt to be removed from the brine batch tank; and
a flow control valve disposed in the brine conduit and configured to prevent water flow from the master control valve to the brine batch tank thereby preventing the softener from operating in the brine generation mode.

2. The improvement of claim 1, wherein the flow control valve is a check valve.

3. The improvement of claim 2, wherein the brine supply apparatus comprises a storage tank, a fill conduit connecting the storage tank to the brine batch tank, and a fill valve disposed in the fill conduit for managing the flow of brine from the storage tank to the brine batch tank.

4. The improvement of claim 3, further comprising a sensor for sensing volume of brine in the brine batch tank and initiating respective high and low level signals at a predetermined volumes in the brine batch tank, a time delay device configured to receive the low level signal and initiate, after a pre-determined time interval after receipt of the low level signal, an actuator open signal, and an actuator on the fill valve configured to open the fill valve upon receipt of the actuator open signal and to close the fill valve upon receipt of the high level signal.

5. The improvement of claim 4, further comprising an adjustable timer configured to enable the pre-determined time interval to be varied.

6. The improvement of claim 4, wherein the sensor is configured to monitor fluid level of brine in the batch tank.

7. The improvement of claim 4, wherein the sensor is configured to monitor a volume of brine entering the batch tank through the fill line.

8. A method for retrofitting a residential salt-based ion exchange water softener system with a brine delivery system, the softener system having an ion exchange tank containing an ion exchange media, a raw water inlet conduit, a softened water discharge conduit, a waste water conduit, a crystalline salt-filled brine batch tank having a brine conduit operably connected thereto, and a master control valve connected to the ion exchange tank, the master control valve having a controller configured to manage alignment of the master control valve to selectively direct the flow of water from the raw water inlet conduit to the ion exchange tank, the waste water conduit, the brine conduit, the softened water discharge conduit, or combinations thereof, thereby defining a plurality of operating modes including at least a soften mode wherein the master control valve is aligned to direct water from the raw water inlet conduit through the ion exchange tank and to the water discharge conduit, a brine generation mode wherein the master control valve is aligned to direct a pre-determined volume of water from the raw water inlet conduit to the brine batch tank via the brine conduit whereupon crystalline salt contained in the brine batch tank interacts with the raw water to create a regeneration batch volume of brine solution, a regeneration mode wherein the master control valve is aligned to withdraw the regeneration batch volume of brine solution from the brine batch tank via the brine conduit, direct the brine solution through the ion exchange tank, and to discharge the brine solution to the waste discharge conduit, the method comprising the steps of:
providing a flow control valve configured to limit flow therethrough to a single direction;
providing a sensor for sensing volume of brine in the brine batch tank and initiating respective high and low level signals indicative of predetermined high and low volumes in the brine batch tank;
providing a brine supply apparatus operably connected to the brine batch tank by a brine fill conduit, the brine supply apparatus configured to selectively permit liquid brine to be supplied to the batch tank for regeneration of the softener system responsive to the sensor level signals;
removing the crystalline salt from the brine batch tank;
installing the flow control valve in the brine conduit so that brine flow is prevented from the master control valve to the brine batch tank;
filling the brine batch tank with the high volume of brine;
operating the softener system in the brine fill cycle in which the master control valve directs water under pressure into the brine conduit and water flow therethrough is prevented by the first valve;
operating the softener system in the brine draw cycle in which the master control valve draws brine from the brine batch tank for regeneration of the ion exchange media; and
operating the softener system in the normal service cycle in which the master control valve isolates the brine conduit.

9. The method of claim 8, further comprising the following steps:
providing a time delay device configured to receive the low level signal and initiate, after a pre-determined time interval after receipt of the low level signal, a brine fill signal and conveying the brine fill signal to the brine supply apparatus; and
supplying by the brine supply apparatus brine to the brine batch tank until the high level signal is conveyed by the sensor to the brine supply apparatus.

10. The method of claim 9, wherein the flow control valve is a check valve.

11. The method of claim 10, wherein the time delay device is an adjustable timer configured to enable the predetermined time interval to be selectively varied.

12. The method of claim 11, wherein the sensor is configured to monitor fluid level of brine in the batch tank.

13. The method of claim 11, wherein the sensor is configured to monitor a volume of brine entering the batch tank through the fill line.
